(19) United States
(12) Patent Application Publication
(10) Pub. No.: US 2008/0079272 A1
(43) Pub. Date: Apr. 3, 2008

(54) Sweep-forming apparatus for a composite metal-plastic bumper beam

(76) Inventor: Naji Arwashan, Birmingham, MI (US)

Correspondence Address: NAJI ARWASHAN, P.O. BOX 2392, BIRMINGHAM, MI, 48012, US

(21) Appl. No.: 11/536,281

(22) Filed: Sep. 28, 2006

(51) Int. Cl. B60R 19/03

(52) U.S. Cl. 293/120

(57) ABSTRACT

An apparatus and associated method is disclosed for introducing a curvature or sweep into a previously rolled-formed elongated thin-wall metal beam with a closed box cross section. A plastic insert is placed inside the elongated straight beam. The curvature is introduced by forming the beam in a press where the upper and lower tools come in contact with the outside of the beam. The two sides of the cross section of the beam will rotate inward in a symmetrical way, while the beam is formed in the longitudinal direction to the designed curvature. The plastic insert rotates and bends inside the beam, providing internal support to keep the cross sections of the beam uniform, and to ensure the forming of the beam to the predetermined curvature without buckles or wrinkles.

### CROSS-REFERENCE TO RELATED APPLICATIONS

U.S. Patent Documents

| | | | |
|---|---|---|---|
| 169994 | November, 2004 | Renzzulla | 72/173. |
| 745194 | June, 2005 | Bladow | 293/102. |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Motor vehicles are normally designed with a front and rear bumper system to absorb the energy in case of an impact and to transfer the impact load to the rail of the vehicle. A bumper system consists normally of three components: fascia, foam or plastic energy absorber, and a bumper beam. The bumper beam or often referred to it as simply the bumper is typically rolled-formed from a strip of sheet steel to have a predetermined transverse cross section that ensures the rigidity and stiffness of the bumper. The bumper beam normally goes also through a second set of roll-forming operation to provide it with a curvature in the longitudinal direction normally called in the industry “sweep”.

The crashworthiness of the vehicle requires high strength performance from the bumper. This can be achieved by using heavy gauge for the metal beam. However, in today's world of high energy prices, a light bumper is a must. To combine the high-strength requirement with the low weight condition, advanced or even ultra high strength steel can be the solution. Most commercial methods that are used to sweep a bumper beam are in practice different forms of combined intrusion and bending as it is well explained in U.S. Pat. No. 169,994. Those methods are in general limited to handling mild steel, or limited to a shallow sweep when high-strength steel is used. There is a very old technique called hot-forming that has resurfaced lately to form a bumper beam using boron steel. The technique relies on the two facts that steel becomes softer to form when heated, and also can obtain an ultra high strength (200-220 ksi) if heated to a temperature of 900c and then quenched. The implementation of U.S. Pat. No. 745,194 depends entirely on this hot forming technique. However, two major shortcomings stand out. First the excessive cost of energy used to heat the steel before stamping. Second, the beam consists of a closed section and quenching after forming is done only to the outside face of the beam, leaving the bumper with inconsistent strength through its thickness.

### BRIEF SUMMARY OF THE INVENTION

To meet the need identify above, the present invention provides a method for sweep-forming an advanced/ultra high strength steel bumper beam using conventional press machines and equipments. The invention consists of placing a plastic insert inside a closed section beam, then forming the beam in a press to introduce the desired curvature and to form the beam to a new predetermined cross section profile. The lower tools of the press are designed to push the bottom two side of the beam to rotate inward forming to the new predetermined cross section. The upper tools press the top face of the beam bending it to the predefined curvature. An end-insert cap tool is placed at both ends of the beam. The caps rotate around the longitudinal and transversal axes simultaneously while translating vertically guiding the ends of the beam to take the intended shape and location. The plastic insert inside the beam rotates and bend with the beam pushing against the upper and lower faces of the beam preventing them from collapsing, and also pressing the lower face of the beam and preventing wrinkles from developing. The final product is a curved beam with smooth lower surface valid for mounting on it the brackets of the vehicle's rails, as well as any other possible attachments. The plastic insert stays inside the beam and contributes to the beam total stiffness.

### BRIEF DESCRIPTION OF THE SEVERAL VIEWS OF THE DRAWINGS

FIG. 1 is an isometric view of the steel beam before forming

FIG. 2 is a cross section of the steel beam before forming

FIG. 3 is an isometric view of the plastic insert

FIG. 4 is a view of the plastic insert from bottom

FIG. 5 is a cross section of the steel/plastic composite beam

FIG. 6 is a side view of the beam placed inside the forming tools

FIG. 7 is an isometric view of the beam placed inside the forming tools

FIG. 8 is a view from right lower angle of the composite beam and the tools

FIG. 9 is a cross section of the composite beam, and the tools in the center zone before forming

FIG. 10 is a cross section of the composite beam, and the tools in the end zone before forming

FIG. 11 is a side view of the beam and the tools after forming

FIG. 12 is an isometric view of the beam and the tools after forming

FIG. 13 is a view from right lower angle of the composite beam and the tools after forming

FIG. 14 is an isometric view of the beam after forming

FIG. 15 is an isometric view of the beam from bottom after forming

FIG. 16 is a side view of the plastic insert after forming

FIG. 17 is an isometric view of the plastic insert after forming

FIG. 18 is a cross section of the composite beam, and the tools after forming

FIG. 19 is longitudinal cross section of the composite beam

FIG. 20 is longitudinal cross section in the end part of the composite beam

### DETAILED DESCRIPTION OF THE INVENTION

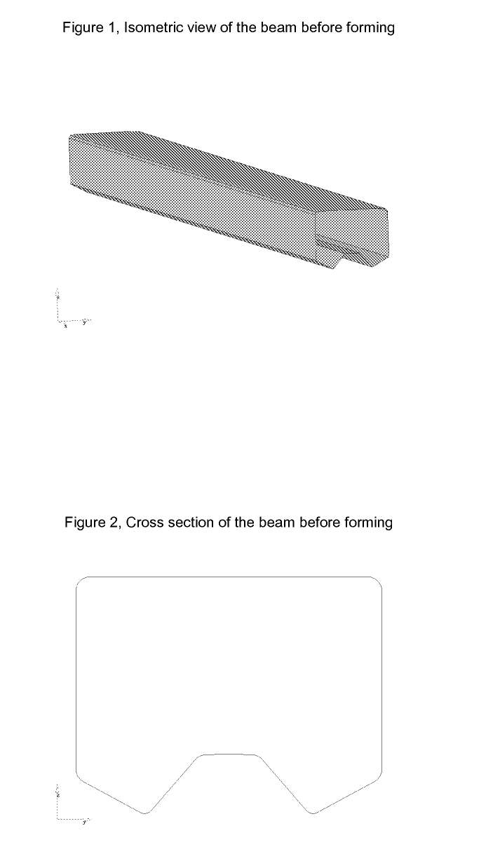

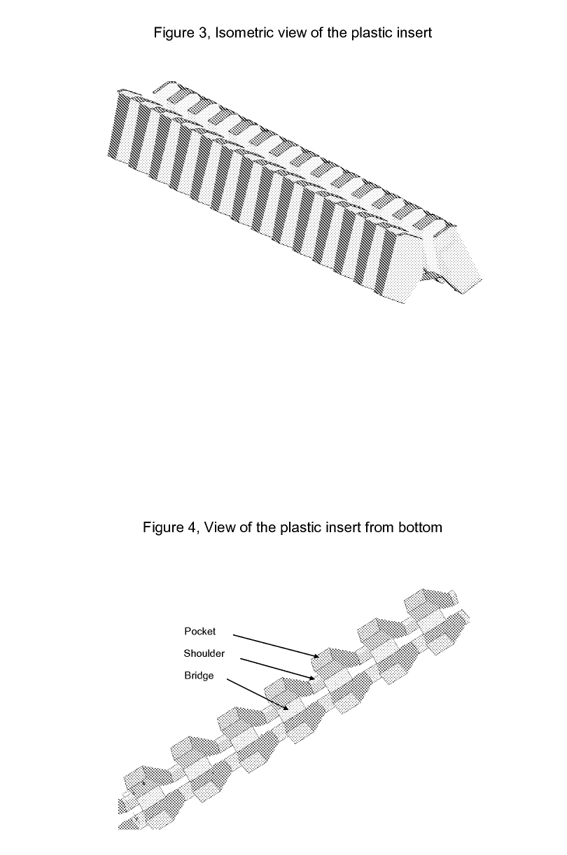

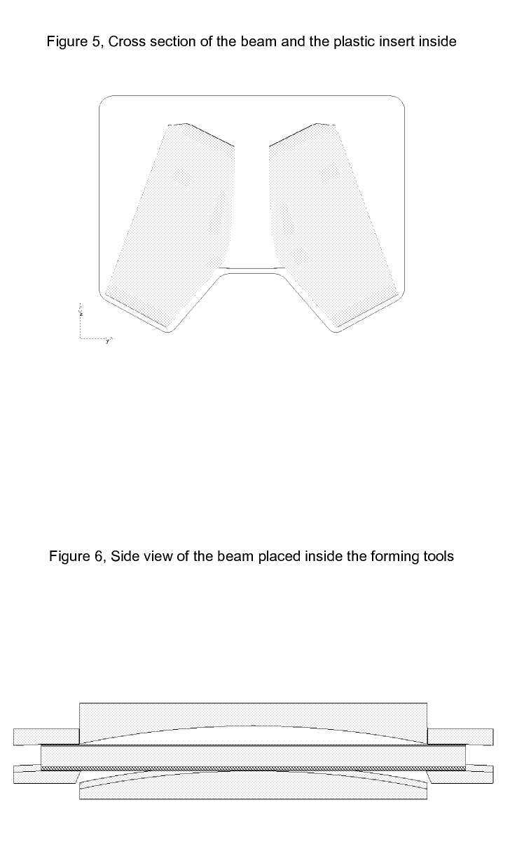

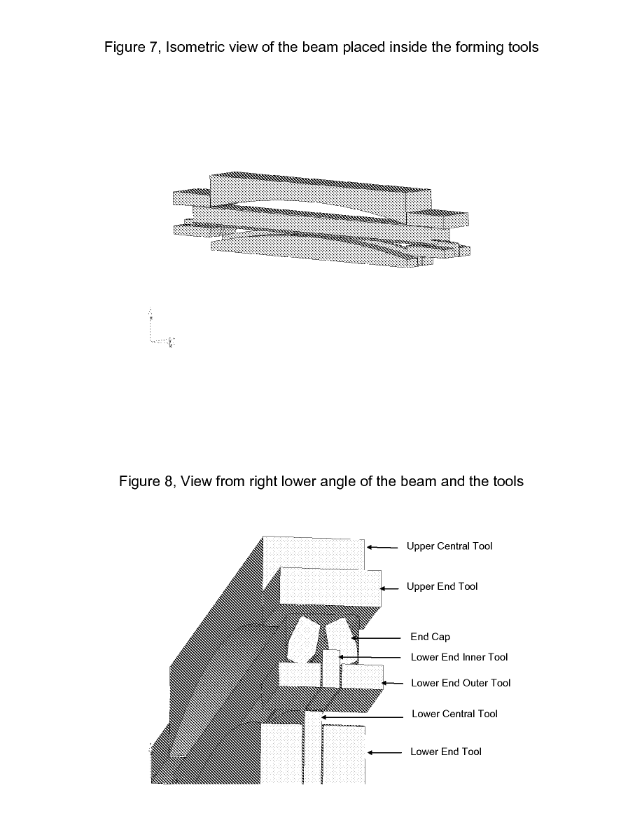

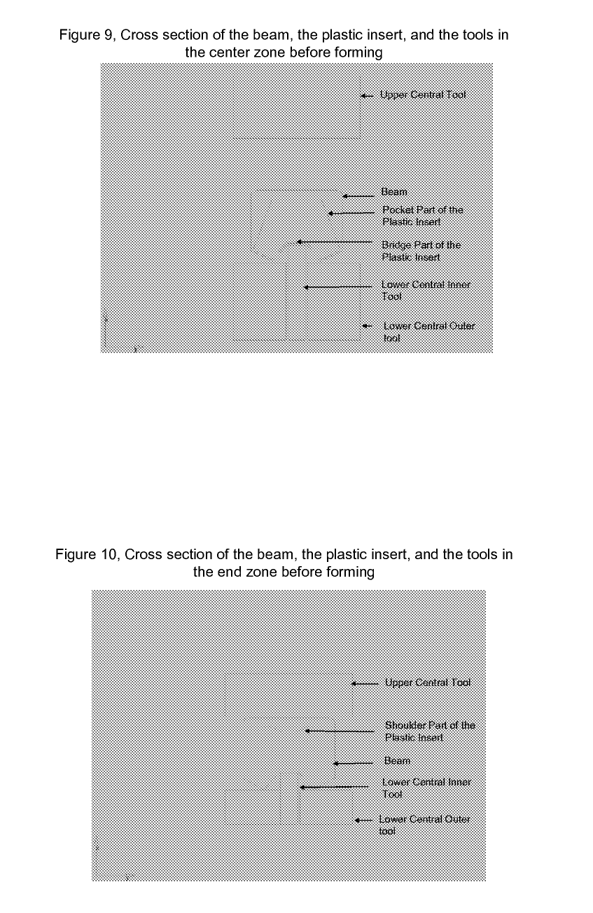

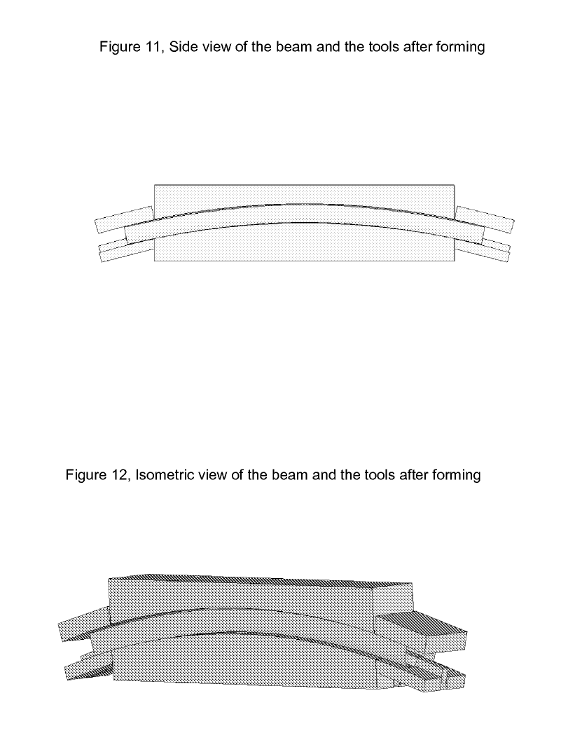

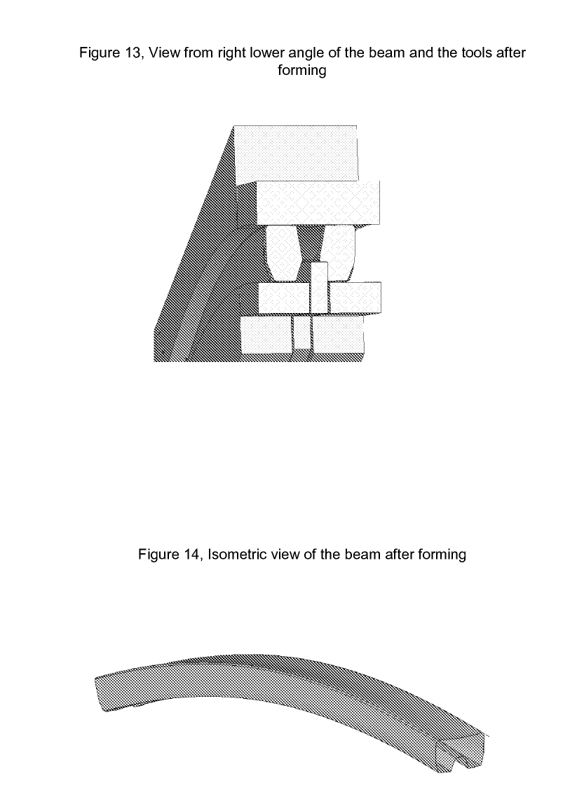

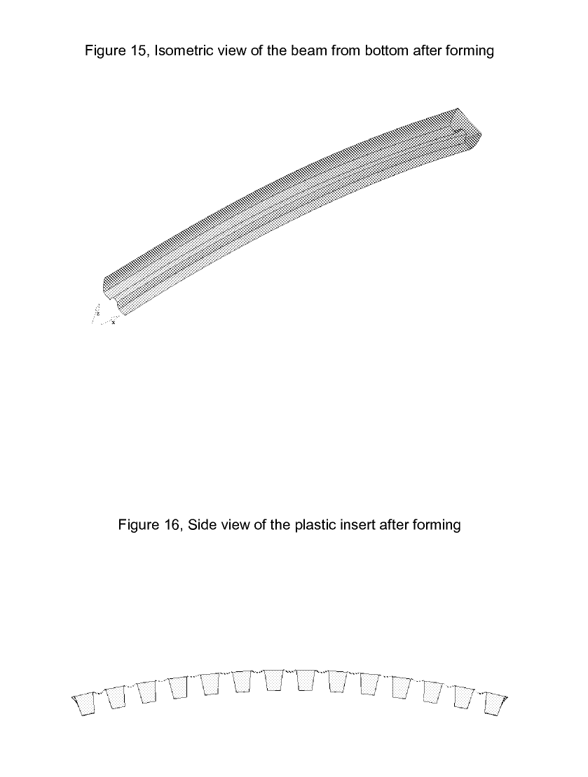

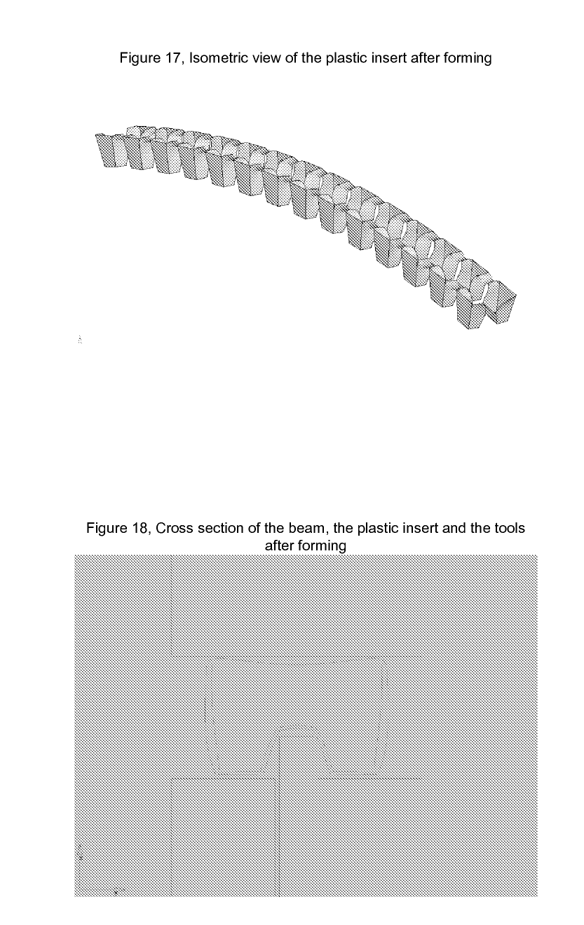

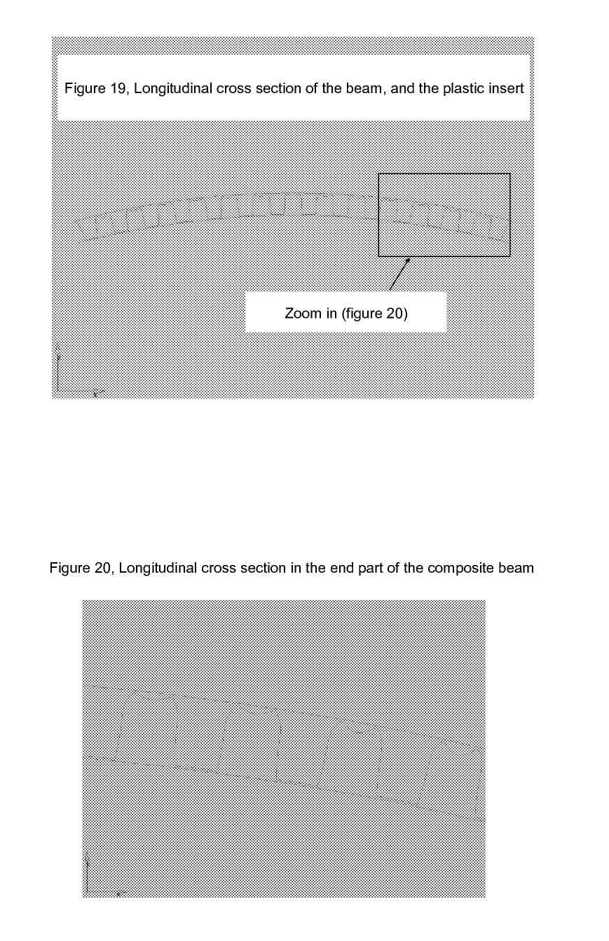

FIGS. 1 and 2 show a steel straight beam with a uniquely designed closed cross section. Thickness of the beam is equal to 1.5 mm. The beam is roll-formed using conventional widely available roll-forming technology. FIG. 3 shows the plastic insert (Young's modulus 2,000 MPa, and yield strength 50 MPa) placed inside the beam. The insert consists of two symmetrical halves (FIGS. 3 and 4). Each half consists of fourteen pockets (thickness equal to 3 mm) connected together with “shoulders” (thickness 2 mm). The two halves of the insert are connected together with “bridges” (thickness 2 mm). The insert is designed to be manufactured using conventional molding. The straight composite beam (steel beam with plastic insert inside) is placed inside a press machine (FIGS. 6, 7 and 8) laying on the lower tools, and fixed in place by using rigid caps inserted at the two ends of the beam (FIG. 8). The upper tools consist of two parts (FIGS. 7 and 8): central one that moves only vertically, and end part that rotates around the transverse axis while it moves vertically to home position (FIGS. 12 and 13). Lower tools (FIGS. 7 and 8) consist of tow parts: central part moving only vertically and end part rotating around transverse axis while moving vertically. Each part of the lower tools consists of inner rail and two symmetrical outer rails. The vertical motion of the lower inner tools differs from the motion of the lower outer tools. That difference in the motion is responsible for pushing the two sides of the cross section of the beam to rotate inwardly forming to the new predetermined cross section. The upper tools push the beam downward forcing it to form to the predetermined curvature. The end caps rotate around the transverse axis and the longitudinal axis simultaneously while they translate vertically to home position (FIG. 13). The motion of the caps helps form the ends of the beam to the desired shape. The plastic insert inside the beam follows the motion of the beam: the shoulders bend allowing the insert structure to follow the imposed curvature (FIGS. 16 and 17), and the bridges bend allowing the two halves of the insert to rotate inward taking the new shape of the cross section of the beam (FIG. 18). The pockets of the insert provide an internal support for the upper and lower faces of the beam preventing them from collapsing (FIGS. 19 and 20), the bottom face of the pockets press against the lower face of the beam preventing wrinkles and buckles from developing, and ensuring the uniformity of the cross section of the beam along the longitudinal axis. At the end of the forming operation a curved beam (FIGS. 14 and 15) is obtained with a uniform new cross section similar to a tooth (FIG. 18). The new cross section is symmetrical with two flat segments at its bottom. The flatness of the bottom is needed for mounting the brackets of the rails on the beam as well as any other attachments. The plastic insert stays inside the beam and contributes to the bumper beam energy absorption during a front or rear impact.

The embodiments of the invention in which an exclusive property or privilege is claimed are defined as follows:

1. A steel/plastic composite curved bumper beam for a vehicle comprising:
Two-cell uniform box-section beam of high strength steel bended to a predetermined curvature. The two cells rotate symmetrically inward during the bending of the straight beam shaping a new uniform cross section for the curved beam where bottom surface is vertical relative to vehicle frame.
Plastic insert is placed inside the steel beam before forming. The insert provides support to the beam from inside the box section assisting the beam to form to the desired shape.

2. A method to bend the composite beam claimed in 1, comprising:
placing the composite beam in a press machine with lower, upper and end-insert cap tools. Upper and lower tools consist of two parts: central part that moves only vertically and end part (at each end of the beam) that rotates around transverse axis while translates vertically. The end-insert caps rotate around the transverse axis and the longitudinal axis simultaneously while translating vertically to home position.
